(19) United States
(12) Patent Application Publication
(10) Pub. No.: US 2025/0379541 A1
(43) Pub. Date: Dec. 11, 2025

(54) CONNECTING ELEMENT FOR PHOTOVOLTAIC MODULES AND METHOD FOR MOUNTING PHOTOVOLTAIC MODULES

(71) Applicant: GREENTI SAGL, Lugano (CH)

(72) Inventor: Daniel LEPORI, Castagnola (CH)

(21) Appl. No.: 19/107,929

(22) PCT Filed: Aug. 31, 2023
(86) PCT No.: PCT/EP2023/073897

§ 371 Date: Feb. 28, 2025

(30) Foreign Application Priority Data
Sep. 1, 2022 (CH) CH001022/2022

(51) Int. Cl. H02S 20/00

(52) U.S. Cl. CPC H02S 20/00

(57) ABSTRACT

Provided is a connecting element (10) for connecting a two- or three-dimensional structure, in particular a photovoltaic module (1), to a support structure (20). The connecting element (10) comprises an upper portion (11) and a lower portion (12). The border of the upper portion (11) and the lower portion (12) is indicated by a convex run (11, 12). The upper portion (11) provides a support surface (110) for mounting a photovoltaic module (1). The lower portion (12) comprises a concave run (121) for being clamped on a support structure (20) comprising a shape basically complementary to the lower portion (12). Moreover, a set comprising a connecting element (10) and a support structure (20) is provided. In addition, a method for connecting a two- or three-dimensional structure, in particular a photovoltaic module (1), to a support structure (20) and a use of a connecting element (10), of a set, or of a method for mounting a two- or three-dimensional structure, such as a photovoltaic module (1), a brick, a shielding or alike to a rooftop, a facade, a greenhouse, urban fields, sound barriers, a movable/stationary watering agriculture or alike are provided.

Not only since the climate change and the imminent energy crisis are threatening humanity, the call for alternative energy becomes louder and louder. In the meantime, about 20% of humans' global energy consumption is renewables, including almost 30% of electricity. The renewable energy sector is growing fast, also because of renewable energy systems becoming rapidly more efficient and cheaper. The four most popular renewable sources are sunlight, wind, water and geothermal heat, with sunlight having the largest capacity. Solar photovoltaic has specific advantages as an energy source: once installed, its operation generates no pollution and no greenhouse gas emissions, it shows simple scalability in respect of power needs and silicon has large availability in the Earth's crust. However, to make maximum use of this technology it is beneficial to provide improvements for the whole lifespan of photovoltaic modules beginning with the extraction of the raw material and the fabrication of the photovoltaic modules, going further to the transport and installation of the photovoltaic modules and ending with the removal, recycling and disposal of the photovoltaic modules having reached the end of the lifespan.

The present invention relates to the technical field of photovoltaic modules and in particular to the field of mounting photovoltaic modules. Besides mounting photovoltaic modules on rooftops, the present invention proposes a connecting element and methods for mounting photovoltaic modules also on facades of buildings, greenhouses, urban fields, sound barriers, stationary watering agriculture or movable watering agriculture, for instance.

The object of the present invention is to provide a connecting element for—but not limited to—photovoltaic modules, which connecting element allows a fast, convenient, and secure mount.

This object is achieved by a connecting element according to claim 1.

Provided is a connecting element for connecting a two- or three-dimensional structure, in particular a photovoltaic module, to a support structure. The connecting element comprises an upper portion and a lower portion. The border of the upper portion and the lower portion is indicated by a convex run. The upper portion provides a support surface for mounting a two- or three-dimensional structure, in particular a photovoltaic module. The lower portion comprises a concave run for being clamped on a support structure comprising a shape basically complementary to the lower portion.

In one embodiment of the connecting element according to the invention, which may be combined with any of the embodiments still to be addressed unless in contradiction, the lower portion comprises a first leg and a second leg. The legs are spaced apart in a basic position. Moreover, the connecting element is designed flexible such that the legs can be further spaced by applying a force. The force can space apart the legs by a distance of 0.1 to 5% or up to 10% in reference to their distance in the basic position, for instance. The legs are spaced apart such that the legs return into the basic position when no force is applied anymore. A typical force is in the range of what a human can apply by pushing with one or two hands or by stamping with his foot. In Newton spoken the force is between 10 to 1000, in particular between 50 to 500, and further in particular 100 to 250, for instance. For attaching a connecting element to a support structure on a facade it is convenient when less force is required than for attaching a connecting element to a support structure on a roof as on the roof one can apply the force also by standing onto the connecting element whereases at a facade it is only the hands that can apply the force. The required force may depend also on the number of connecting elements intended to be installed. The higher the number of connecting elements per defined area of the target surface (roof, facade, . . . ), the lower the force for joining the connecting element and the support structure can be.

In one embodiment of the connecting element according to the invention, which may be combined with any of the preaddressed embodiments and any of the embodiments still to be addressed unless in contradiction, the upper portion comprises a means for structure stabilization. Such a means can be a screw inserted through two through holes in the upper portion and tightened with a nut, for instance.

In one embodiment of the connecting element according to the invention, which may be combined with any of the preaddressed embodiments and any of the embodiments still to be addressed unless in contradiction, the upper portion comprises a concave run for structure stabilization.

In one embodiment of the connecting element according to the invention, which may be combined with any of the preaddressed embodiments and any of the embodiments still to be addressed unless in contradiction, the connecting element is made of stainless steel, aluminum, plastic, or fiber reinforced plastic. In addition, or as an alternative the material thickness (or material strength) is between 0.1 and 5.0 mm and in particular between 1.0 and 3.0 mm.

In one embodiment of the connecting element according to the invention, which may be combined with any of the preaddressed embodiments and any of the embodiments still to be addressed unless in contradiction, the connecting element comprises a mechanical means for securing the two- or three-dimensional structure, in particular a photovoltaic module. The mechanical means may be C-, H-, I-, L-, or Z-shaped. In the example of a L-shape one part of the L comprises a means, in particular a through hole, for being fixed to the connecting element, and the other and distinct part of the L comprises a recess for accommodating the two- or three-dimensional structure, in particular the photovoltaic module.

In one embodiment of the connecting element according to the invention, which may be combined with any of the preaddressed embodiments and any of the embodiments still to be addressed unless in contradiction, the lower portion comprises a convex run. The convex run can be located after the concave run of the lower portion viewed in direction from the upper portion to the lower portion. The convex run may be located at the very end of the lower portion opposite to the upper portion.

In one embodiment of the connecting element according to the invention, which may be combined with any of the preaddressed embodiments and any of the embodiments still to be addressed unless in contradiction, the material thickness of the upper portion and the lower portion are identical. Alternatively, the material thickness of the upper portion can be lower than the material thickness of the lower portion. Alternatively, the material thickness of the upper portion is higher than the material thickness of the lower portion. Alternatively, the material thickness of the upper portion and the lower portion are identical apart from the areas of at least one of the convex run separating the upper and lower portion, the concave run of the upper portion, the concave run of the lower portion, and the convex run of the lower portion.

In one embodiment of the connecting element according to the invention, which may be combined with any of the preaddressed embodiments and any of the embodiments still to be addressed unless in contradiction, the stiffness of the upper portion and the lower portion are identical. Alternatively, the stiffness of the upper portion can be lower than the stiffness of the lower portion.

Alternatively, the stiffness of the upper portion is higher than the stiffness of the lower portion. Alternatively, the stiffness of the upper portion and the lower portion are identical apart from the areas of at least one of the convex run separating the upper and lower portion, the concave run of the upper portion, the concave run of the lower portion, and the convex run of the lower portion.

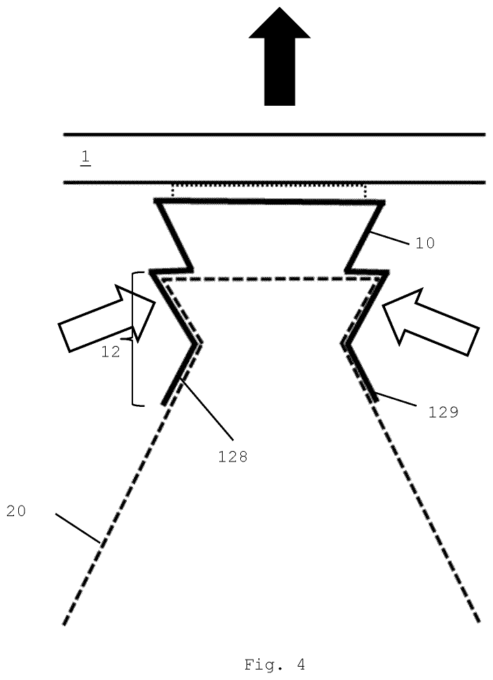

Depending on where (i.e., target surface) the two- or three-dimensional structure (e.g., photovoltaic module) is to be installed, different main forces act on the connecting element. In case the two- or three-dimensional structure is to be mounted on a roof, the connecting element must prevent the two- or three-dimensional structure from being lifted when strong winds are blowing, for example (see, e.g., FIG. 4). In case the two- or three-dimensional structure is to be mounted on a facade, the connecting element must prevent the two- or three-dimensional structure from sliding downwards. Depending on these needs, the connecting elements are designed differently. For the facade-mount it is advisable to have a “longer” connecting element (meant is the extension into the image plane of the cross-sectional views) for better friction fit. A better friction fit can also be achieved with a longer first and second leg of the lower portion of the connecting element. Projections at the free end portion of the lower portion also help. Another means to adjust the clamping characteristic is the change of the material thickness along the run of the connecting element. For a roof-mount it might be advisable to have a rather stiff upper portion and a less stiff lower portion. When tensile forces act on the support surface of the upper portion, the upper portion itself is not deformed and passes on the force to the lower portion, which in turn is slightly deformed, namely stretched, between the convex run building the edge to the upper portion and the concave run of the lower portion. As a result, the clamping becomes more intense due to the sandglass-shape of the support structure. For a facade-mount it might be advisable to have a rather stiff lower portion and a less stiff upper portion. This is because tensile forces do have less impact on the clamping characteristic as the elasticity of the upper portion absorbs theses forces and thus maintains the shape of the lower portion, which shape provides sufficient friction for vertical fit. Instead of or in addition to a variable material thickness throughout the connecting element, it may only be the areas of the convex or concave run that comprise less or more material to adapt the spring characteristics.

In one embodiment of the connecting element according to the invention, which may be combined with any of the preaddressed embodiments and any of the embodiments still to be addressed unless in contradiction, the connecting element is produced by extruding.

In case of the connecting element having a variable material thickness, extruding is the best praxis for producing the connecting element. Manufacturing of such a connecting element with a bending machine is possible, but extremely challenging. As normally many connecting elements are required per project, the production by a bending machine becomes also cost intense. For extruding only one model must be provided and then the connecting element can be produced as bulk connecting element separable in single sections of desirable length.

A further aspect of the invention addresses a set for connecting a two- or three-dimensional structure, in particular a photovoltaic module, to a support structure. The set comprises connecting element as described in one of the preceding embodiments and a support structure comprising a shape basically complementary to the lower portion of the connecting element with its concave run.

In one embodiment of the set according to the invention, which may be combined with any of the preaddressed embodiments and any of the embodiments still to be addressed unless in contradiction, the support structure allows for tilting the connecting element around an axis

This is achieved in particular by the support structure being tiltable itself or by being mounted on or to a tiltable device.

To maximize the efficiency, it is beneficial to not necessarily install the photovoltaic modules in a standard rooftop 10° fixed tilt mono-facial solar array, but to provide more flexibility regarding the orientation to the sun. An adjustable orientation can be achieved by means of telescoping legs, for instance. But single-axis trackers usually moving from the east to the west and following the Sun's direction can also be implemented, for instance. The support structure can be an integrate part of the telescoping legs or trackers, but it can also be designed separately and mechanically linked thereto.

An even further aspect of the invention addresses a method for connecting a two- or three-dimensional structure, in particular a photovoltaic module, to a support structure. The method comprises the step of providing a connecting element according to one of the previously described connecting elements and the provision of a support structure having a shape basically complementary to the lower portion of the connecting element with its concave run. Alternatively, the method comprises the step of providing a set as previously described. Moreover, the method comprises the mounting of a two- or three-dimensional structure, in particular a photovoltaic module, to the support surface of the upper portion of the connecting element. The mounting can be accomplished by gluing, screwing, clamping, or a combination thereof, for instance. In addition, the method comprises the positioning of the lower portion of the connecting element on top of the support structure. Afterwards, enough force is applied to the connecting element to press the lower part onto the support structure. The force can be applied by a human or by a machine.

In one embodiment of the method according to the invention, which may be combined with any of the preaddressed embodiments and any of the embodiments still to be addressed unless in contradiction, the step of providing a connecting element comprises producing the connecting element by extruding. Alternatively, it is the step of providing a set which comprises producing the connecting element by extruding.

An again further aspect of the invention addresses the use of a connecting element as previously described, of a set as previously, or of a method as previously described for mounting a two- or three-dimensional structure, such as a photovoltaic module, a brick, a lamp, a billboard, or a shielding (on) to a target surface such as a rooftop, a facade, a greenhouse, urban fields, a movable watering agriculture, a stationary watering agriculture or alike. Depending on what is to be mounted where, it might be beneficial to assemble all three components (i.e., connecting element, support structure, and two- or three-dimensional structure, such as photovoltaic module) already in a fabric and transport this composition to the destination, where the photovoltaic module, brick, shielding or whatever structure to be installed shall be installed. Either the two- or three-dimensional structure is attached to the connecting element first and then the connecting element is clamped onto the support structure, or the clamping is done first and the two- or three-dimensional structure is fixed to the connecting element afterwards. In other application fields it is more convenient to previously install the support structure on the roof or alike (i.e., the mounting target surface), to already pre-assemble the connecting element and the two- or three-dimensional structure in a fabric, and to then mount the two- or three-dimensional structure by just clicking the connecting element already connected to the two- or three-dimensional structure onto the support structure. However, it is also possible to assemble the connecting element and the two- or three-dimensional structure on-site instead of in a fabric, e.g., on the ground of the construction site or directly on the mounting target surface (roof, facade . . . ). Alternatively, it is possible two assemble all three components on-site.

In case of an installation on watering agriculture, the solar installation may replace existing structures, with no more need for plastic tunnels or greenhouses screens. This way, large areas become available for producing renewable energy.

The invention shall now be further exemplified with the help of figures. The figures schematically show:

FIG. 1 a schematic view of a connecting element according to the invention;

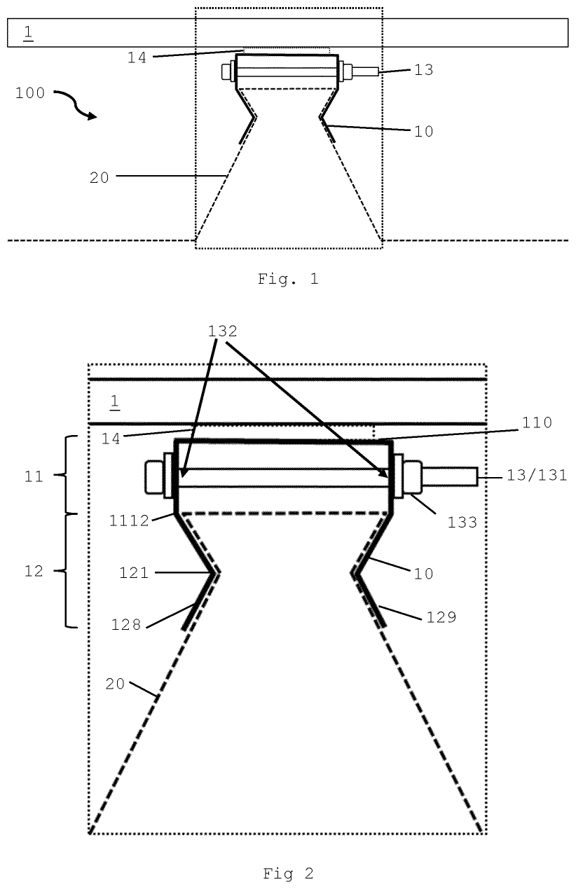

FIG. 2 a schematic close-up view of the connecting element according to FIG. 1;

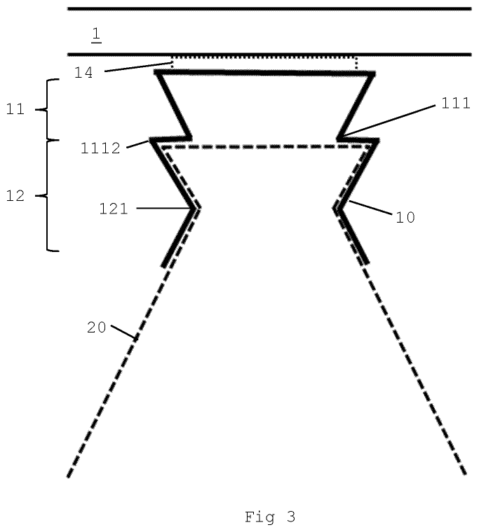

FIG. 3 a schematic view of an embodiment of a connecting element according to the invention;

FIG. 4 a schematic illustration of the mode of operation of a connecting element according to the invention;

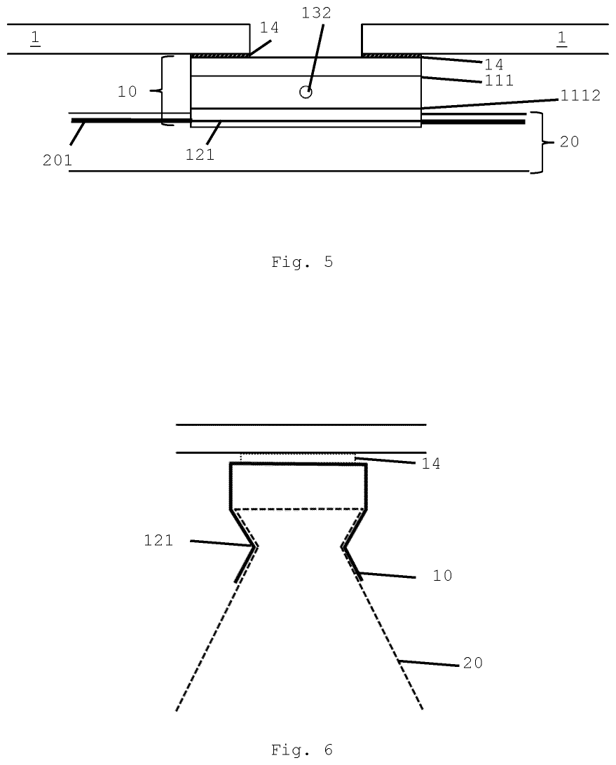

FIG. 5 a schematic side view of the embodiment of the connecting element according to FIG. 3;

FIG. 6. a schematic view of an embodiment of a connecting element according to the invention;
a connecting element according to the invention;

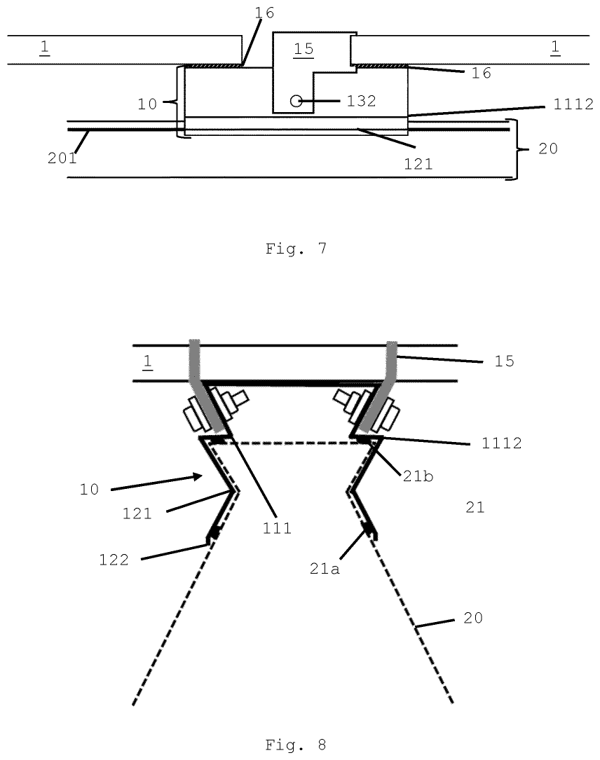

FIG. 7 a schematic side view of an embodiment of the connecting element according to the invention; and

FIG. 8 a schematic view of an embodiment of a connecting element according to the invention.

FIG. 1 is a schematic cross-sectional illustration of a connecting element 10 according to the invention. On top of the connecting element 10 a photovoltaic module 1 is mounted and attached to the connecting element 10 by a connecting means, such as a glue 14 for instance. The connecting element 10 itself is located on top of a support structure 20 and partially encloses an upper part of the support structure 20. In order to give the connecting element 10 higher stability where it is not in contact with the support structure 20, a means for stabilization 13 is arranged. The connecting element of FIG. 1 will be explained in more detailed by means of the close-up view shown in FIG. 2. Please note that FIG. 1 is actually also showing a set 100 of a connecting element 10 and a support structure 20, as here not only a part but a whole support structure 20 is shown.

FIG. 2 shows a schematic close-up view of the connecting element of FIG. 1. The connecting element 10 comprises in general two portions, an upper portion 11 and a lower portion 12. It is the upper portion 11 that provides for a support surface 110 for mounting the photovoltaic module 1 or any other plate-shaped or two-dimensionally extended object, as the invention is not limited to the mounting of photovoltaic modules. The boarder between the upper portion 11 and the lower portion 12 is marked or defined by a convex run 1112 or progression of the material of the connecting element 10. The lower portion 12 comprises a tapering and is thus basically sandglass-shaped. The tapering is represented by a concave run 121 of the material of the connecting element 10. For a secure hold of the connecting element 10 on the support structure 20, the support structure 20 is designed comparable to a corrugated sheet, however, the heights show not the classical U-shape in a cross-sectional view, but a shape complementary to the shape of the lower portion 12 of the connecting element 10 and thus also a sandglass-shape. The lower portion 12 comprises two free legs, a first leg 128 and a second leg 129. These legs 128, 129 are movable in relation to one another by applying a force. When no force is applied, the legs rest in a basic position showing a certain distance between the two legs. By applying a force, the legs 128, 129 can either be moved apart or pushed together, thereby increasing or decreasing the distance between the legs 128, 129. When the application of the force stops, the legs return into the basic position. In other words, the lower portion 12 is elastic or flexible, at least to a certain extend. This flexibility is responsible for that the lower portion 12 of the connecting element 10 can be imposed on at least a top part of the complementary shaped height of the support structure 20. As a counterbalance to the flexibility of the lower portion 12 comprises the upper portion 11 a higher stiffness and is rather inflexible/inelastic. To provide for an even higher stiffness, the upper portion 11 may comprise means for further stabilizing this part of the connecting element 10, for instance by a stabilization structure 13 such as a screw 131 lead through holes 132 in the upper portion 12 and secured by a nut 133. In addition, or as an alternative, the different extends of flexibility or stiffness of the upper 11 and the lower portion 12 can be regulated or tuned by variating material strength, for instance. A further or alternative possibility to adjust the different extends of flexibility or stiffness is to choose certain length ratios of the individual portions, not only of the upper portion 11 and the lower portion 12, but also of all sub-portions defined or rather separated by concave or convex' runs of the material of the connecting element 10. Besides the length ratios it is also the degree or intensity/extend of the concave or convex' runs that has an impact on the stability of the corresponding upper/lower portion 11,12.

FIG. 3 shows a schematic cross-sectional illustration of an embodiment of a connecting element 10 according to the invention. Again, the support structure 20 comprises sandglass-shaped portions where the lower portion 12 of the connecting element 10 can be clamped upon. However, the specific design of the connecting element 10 differs from the one shown in FIGS. 1 and 2 in that the upper portion 11 comprises a concave run 111 and is not straight. The concave run 111 provides for a higher stability of the upper portion 11. To even further strengthen the upper portion 11, it is possible to additionally implement a stabilization structure as described in connection with FIGS. 1 and 2, for instance. The lower portion 11 with its concave run 121 is designed comparable to the one described based on FIGS. 1 and 2. The upper 11 and lower portion 12 are again divided by means of a convex run 1112, i.e., a convexity or raise/increase. A photovoltaic module 1 or any other basically two-dimensional extending object is attached to the upper portion 11 by a glue 14, for instance.

FIG. 4 shows a schematic cross-section through an embodiment of a connecting element 10 according to the invention, based on which the mode of operation of the connecting element according to the invention is illustrated. When a force (indicated by the massive black arrow) is applied to the photovoltaic module 1 or any other structure that is mounted on or attached to the connecting element 10 and tries to remove this module or structure form the remaining construct, this force provokes an induced force (indicated by the two outlines arrows) which causes that the first leg 128 and the second leg 129 of the lower portion 12 hold even stronger onto the support structure 20.

FIG. 5 shows a schematic side view of the embodiment of the connecting element according to FIG. 3. Due to the different perspective more than one photovoltaic module 1 or other structure that is mounted on or attached to the connecting element 10 is visible. In this embodiment the end sections of the connecting element 10 support the photovoltaic modules 1 at their end sections. However, it is also possible that the complete upper surface of the connecting element 10 serves as support surface or/and that only one photovoltaic module 1 is (e.g., centrically) attached to the connecting element 10. The photovoltaic modules 1 are attached by a glue 14, for instance. The connecting element 10 is divided into in total four sections, wherein two sections belong to the upper portion and two sections belong to the lower portion. The upper and lower portion are separated by convexity 1112. Concavities 111 and 121 split the upper section and the lower section in two sub-sections each. The vertical extend of the upper portion in this example is larger than the extend of the lower portion in particular about three times larger. The vertical extend of the upper portion may in general be two to five times larger than the lower portion. Important is that the upper portion is high enough to provide enough space for the junction box and cables (e.g., about 1-2 cm). In case the photovoltaic module comprises a frame, the upper portion might even be higher (e.g., at least 3 cm) such that the frame is enough spaced apart from the support structure 20. The upper section comprises a through hole 132 for implementing a stabilization structure or for attaching a mechanical means for securing the photovoltaic module or comparable other structure, for instance. The connecting element 10 rest upon the support structure 20 and with its lower portion embraces the complementary shaped part of the support structure 20. The complementary shaped part is formed by a recess or concavity 201, which is congruent with the concavity 121 of the lower portion of the connecting element 10.

FIG. 6 is a schematic cross-sectional illustration of a connecting element 10 according to the invention. Opposite to the one shown in FIGS. 1 and 2, the connecting element 10 shown here does not comprise a stabilization structure. All other technical features, in particular the ones indicated by reference signs are identical to the ones shown in connection with FIGS. 1 and 2.

FIG. 7 shows a schematic side view of an embodiment of the connecting element 10 according to the invention. Opposite to the connecting element of FIG. 5, the connecting element 10 shown here comprises an upper portion that is not subdivided by a concave run but is designed straight. Further opposite to the connecting element of FIG. 5, the photovoltaic module 1 is not glued to the connecting element 10 but secured by a mechanical means 15 for securing the photovoltaic module 1. The shown mechanical means 15 is L-shaped and comprises in one part of the L means, such as hole 132, for being fixed to the connecting element 10, in particular to the upper portion of the connecting element 10, and comprises in the other part that is distinct from the one part of the L structure a recess for accommodating the photovoltaic module 1 or other structure. To protect the photovoltaic module 1 from scratches and such, a protection element 16, such as a fiber mat or fleece, is arranged on the support surface of the connecting element 10. All other technical features, in particular the ones indicated by reference signs, are identical to the ones shown in connection with FIG. 5.

FIG. 8 is a schematic cross-sectional illustration of a connecting element 10 according to the invention. The photovoltaic module 1 is placed directly on the support surface of the connecting element 10 and is attached to the connecting element 10 by means of a mechanical means 15 for securing the photovoltaic module 1 that is screwed to the connecting element 10. The mechanical means 15 may comprise the form of a letter-shaped and plate-shaped holder, where the photovoltaic module 1 can be clamped between. For instance, the photovoltaic module 1 is clamped between the upper protrusions of an H-shaped holder, in the cavity formed by a C-shaped holder, or in one of the cavities of a Z-shaped holder. The basic shape of the connecting element 10 with the concave run of the upper portion 111, the concave run of the lower portion 121, and the convex run separating upper and lower portion 1112 dividing the upper and the lower portion is known from FIG. 3, for instance. However, the connecting element 10 shown here comprises in addition a convex run 122 in the lower portion. This convex run 122 is located in the area of the free ending portion of the lower portion, in particular at the very end. In turn, the support structure 20 comprises projections 21a in the area to get in contact with the free ending portion of the lower portion of the connecting element 10 for mechanically interacting with the convex run 122 of the connecting element 10 to further secure the connecting element 10 and thus the photovoltaic element 1. In addition, the support structure 20 comprises projections 21b in the area to get in contact with the portion of the lower portion of the connecting element 10 adjacent to the upper portion for increasing the clamping force and thus for further securing the connecting element 10 to the support structure 20. The projections 21b located in the area to get in contact with the portion of the lower portion of the connecting element 10 adjacent to the upper portion can be arranged on the support structure 20, on the connecting element 10 or both.

Please note that although the figures show individual embodiments of the invention, single technical features explained in connection with one embodiment can well be implemented in another embodiment, unless in contradiction, or single technical features explained in connection with one embodiment can well be omitted, unless being mandatory for the invention. Such adaptions are not meant to be viewed as unallowed intermediate generalizations. Please note further that although the invention is illustrated based on photovoltaic modules, the examples are not limited to photovoltaic modules and are applicable to any kind of two- or three-dimensional structure to be mounted.

Reference Signs

| | |
|---|---|
| 1 | Photovoltaic module |
| 10 | Connecting element |
| 11 | Upper portion of the connecting element |
| 12 | Lower portion of the connecting element |
| 13 | Stabilization structure |
| 14 | Glue |
| 15 | Mechanical means for securing the |
| | photovoltaic module |
| 16 | Protection element |
| 20 | Support structure |
| 21 | Projection |
| 110 | Support surface |
| 111 | Concave run of the upper portion |
| 121 | Concave run of the lower portion |
| 122 | Convex run of the lower portion |
| 128 | First leg of the lower portion |
| 129 | Second leg of the lower portion |
| 131 | Screw |
| 132 | Hole |
| 133 | Nut |
| 201 | Complementary structure of support |
| | structure |
| 1112 | Convex run separating upper and lower |
| | portion |

1. Connecting element (10) for connecting a two- or three-dimensional structure, in particular a photovoltaic module (1), to a support structure (20),
wherein the connecting element comprises an upper portion (11) and a lower portion (12), the border of the upper portion (11) and the lower portion (12) being indicated by a convex run (1112),
wherein the upper portion (11) provides a support surface (110) for mounting a two- or three-dimensional structure, in particular a photovoltaic module (1), and
wherein the lower portion (12) comprises a concave run (121) for being clamped on a support structure (20) comprising a shape basically complementary to the lower portion (12).

2. Connecting element (10) according to claim 1, wherein the lower portion (12) comprises a first leg (128) and a second leg (129), the legs being (128, 129) spaced apart in a basic position,
and wherein the connecting element is designed flexible such that the legs (128, 129) can be further spaced by applying a force, in particular by a distance of 0.1 to 10% and further in particular of 0.1 to 5% in reference to their distance in the basic position, and such that the legs (128, 129) return into the basic position when no force is applied.

3. Connecting element (10) according to claim 1,
wherein the upper portion (11) comprises a means for structure stabilization (13), in particular a screw (131) inserted through two through holes (132) in the upper portion (11) and tightened with a nut (133).

4. Connecting element (10) according to claim 1,
wherein the upper portion (11) comprises a concave run (111) for structure stabilization.

5. Connecting element (10) according to claim 1,
wherein the connecting element is made of stainless steel, aluminum, plastic, or fiber reinforced plastic, and/or
wherein the material thickness is between 0.1 and 5.0 mm, in particular between 1.0 and 3.0 mm.

6. Connecting element (10) according to claim 1,
wherein the connecting element (10) comprises a mechanical means (15) for securing the two- or three-dimensional structure, in particular the photovoltaic module (1), the mechanical means (15) being in particular C-, H-, I-, L-, or Z-shaped and further in particular L-shaped, wherein one part of the L comprises a means, in particular a through hole, for being fixed to the connecting element (10), and wherein the other and distinct part of the L comprises a recess for accommodating the two- or three-dimensional structure, in particular the photovoltaic module (1).

7. Connecting element (10) according to claim 1,
wherein the lower portion (12) comprises a convex run (122), in particular after the concave run (121) of the lower portion (12) viewed in direction from the upper portion (11) to the lower portion (12), and further in particular at the very end of the lower portion (12) opposite to the upper portion (11).

8. Connecting element (10) according to claim 1,
wherein the material thickness of the upper portion (11) and the lower portion (12) are identical, or
wherein the material thickness of the upper portion (11) is lower than the material thickness of the lower portion (12), or
wherein the material thickness of the upper portion (11) is higher than the material thickness of the lower portion (12), or
wherein the material thickness of the upper portion (11) and the lower portion (12) are identical apart from the areas of at least one of the convex run (1112) separating upper and lower portion (11, 12), the concave run (111) of the upper portion (11), the concave run (121) of the lower portion (12), and the convex run (122) of the lower portion (12).

9. Connecting element (10) according to claim 1,
wherein the stiffness of the upper portion (11) and the lower portion (12) are identical, or
wherein the stiffness of the upper portion (11) is lower than the stiffness of the lower portion (12), or
wherein the stiffness of the upper portion (11) is higher than the stiffness of the lower portion (12), or
wherein the stiffness of the upper portion (11) and the lower portion (12) are identical apart from the areas of at least one of the convex run (1112) separating upper and lower portion (11, 12), the concave run (111) of the upper portion (11), the concave run (121) of the lower portion (12), and the convex run (122) of the lower portion (12).

10. Connecting element (10) according to claim 1,
wherein the connecting element (10) is produced by extruding.

11. Set (100) for connecting a two- or three-dimensional structure, in particular a photovoltaic module (1), to a support structure (20), the set comprising a connecting element according to one claim 1 and a support structure (20) comprising a shape basically complementary to the lower portion (11) of the connecting element (10) with its concave run (121).

12. Set (100) according to claim 11, wherein the support structure (20) allows for tilting the connecting element (10) around an axis (x), in particular by being tiltable itself or being mounted on a tiltable device.

13. A method for connecting a two- or three-dimensional structure, in particular a photovoltaic module (1), to a support structure (20), the method comprising the steps of:
Providing a connecting element (10) for the photovoltaic module (1) to the support structure (20), wherein the connecting element comprises an upper portion (11) and a lower portion (12), the border of the upper portion (11) and the lower portion (12) being indicated by a convex run (1112), wherein the upper portion (11) provides a support surface (110) for mounting a two- or three-dimensional structure, in particular a photovoltaic module (1), and wherein the lower portion (12) comprises a concave run (121) for being clamped on a support structure (20) comprising a shape basically complementary to the lower portion (12) and providing a support structure (20) comprising a shape basically complementary to the lower portion (12) of the connecting element (10) with its concave run (121), or providing a set according to claim 11;
Mounting a two- or three-dimensional structure, in particular a photovoltaic module (1), to the support surface (110) of the upper portion (11) of the connecting element (10), in particular by a glue (14);
Positioning the lower portion (12) of the connecting element (10) on top of the support structure (20);
Applying enough force, in particular human or machine force) to the connecting element (10) to press the lower part (12) onto the support structure (20).

14. Method according to claim 13, wherein the step of providing connecting element (10) for the photovoltaic module (1) to the support structure (20), wherein the connecting element comprises an upper portion (11) and a lower portion (12), the border of the upper portion (11) and the lower portion (12) being indicated by a convex run (1112), wherein the upper portion (11) provides a support surface (110) for mounting a two- or three-dimensional structure, in particular a photovoltaic module (1), and wherein the lower portion (12) comprises a concave run (121) for being clamped on a support structure (20) comprising a shape basically complementary to the lower portion (12) or providing a set (100) for connecting the photovoltaic module (1) to the support structure (20), the set comprising the connecting element and the support structure (20) comprising a shape basically complementary to the lower portion (11) of the connecting element (10) with its concave run (121) comprises producing the connecting element (10) by extruding.

15. Use of a connecting element (10) for the photovoltaic module (1) to the support structure (20), wherein the connecting element comprises an upper portion (11) and a lower portion (12), the border of the upper portion (11) and the lower portion (12) being indicated by a convex run (1112), wherein the upper portion (11) provides a support surface (110) for mounting a two- or three-dimensional structure, in particular a photovoltaic module (1), and wherein the lower portion (12) comprises a concave run (121) for being clamped on a support structure (20) comprising a shape basically complementary to the lower portion (12) or set (100) for connecting the photovoltaic module (1) to the support structure (20), the set comprising the connecting element and the support structure (20) comprising a shape basically complementary to the lower portion (11) of the connecting element (10) with its concave run (121) or of a method for connecting a two- or three-dimensional structure, in particular a photovoltaic module (1), to a support structure (20), the method comprising the steps of providing the connecting element (10), or providing the set; Mounting a two- or three-dimensional structure, in particular a photovoltaic module (1), to the support surface (110) of the upper portion (11) of the connecting element (10), in particular by a glue (14); Positioning the lower portion (12) of the connecting element (10) on top of the support structure (20); and Applying enough force, in particular human or machine force) to the connecting element (10) to press the lower part (12) onto the support structure (20), for mounting at least one of the following:
photovoltaic module,
brick,
lamp,
billboard,
shielding,
to at least one of the following:
rooftop,
facade,
greenhouse,
urban fields,
sound barriers,
movable watering agriculture,
stationary watering agriculture.
